(19) United States
(12) Patent Application Publication
(10) Pub. No.: US 2024/0157881 A1
(43) Pub. Date: May 16, 2024

(54) Purse Holding Assembly

(71) Applicant: Edwin Harvilchuck, Aliquippa, PA (US)

(72) Inventor: Edwin Harvilchuck, Aliquippa, PA (US)

(21) Appl. No.: 17/984,353

(22) Filed: Nov. 10, 2022

(51) Int. Cl. B60R 7/04; B60N 2/90; B60R 7/08

(52) U.S. Cl. CPC B60R 7/043; B60N 2/90; B60R 7/08; B60R 2011/0017

(57) ABSTRACT

A purse holding assembly includes a support member that is engageable to a headrest of a vehicle seat such that the support member is oriented to lie on a horizontal plane. A pair of engagements is each attached to the support member and each of the engagements curves outwardly from the support member to define a post opening in each of the engagements. The post opening in each of the engagements insertably receives a respective one of a pair of posts of the headrest of the vehicle seat for attaching the support member to the pair of posts. In this way a strap of a purse can be extended over the support member to suspend the purse for storage. A ball is coupled to the support member to inhibit the strap of the purse from sliding off of the support member.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to holding devices and more particularly pertains to a new holding device for facilitating a purse to be stored in an out of the way location in a vehicle. The device includes a support member and a pair of engagements that are coupled to the support member for insertably receiving posts of a headrest on a vehicle seat thereby orienting the support member on a horizontal plane. The device includes a ball attached to the support member which inhibits a strap of a purse that is placed over the support member from sliding off of the support member.

### (2) Description of Related Art Including Information Disclosed Under 37 CFR 1.97 and 1.98

The prior art relates to holding devices including a holder comprising a member with a slot for receiving posts of a headrest of a vehicle seat which has an angled section and a hanger attached to the member which has a protruding lobe for hanging a purse. The prior art discloses a headrest hook hanger that includes a clamp bracket which clamps a headrest and a pair of curved members each extending away from the clamp bracket to define a coat hook. The prior art discloses a head rest coat hanger which includes a pair of bendable wires that can be shaped into a coat hanger.

### (h) BRIEF SUMMARY OF THE INVENTION

An embodiment of the disclosure meets the needs presented above by generally comprising a support member that is engageable to a headrest of a vehicle seat such that the support member is oriented to lie on a horizontal plane. A pair of engagements is each attached to the support member and each of the engagements curves outwardly from the support member to define a post opening in each of the engagements. The post opening in each of the engagements insertably receives a respective one of a pair of posts of the headrest of the vehicle seat for attaching the support member to the pair of posts. In this way a strap of a purse can be extended over the support member to suspend the purse for storage. A ball is coupled to the support member to inhibit the strap of the purse from sliding off of the support member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a purse holding assembly according to an embodiment of the disclosure.

FIG. 2 is a front view of an embodiment of the disclosure.

FIG. 3 is a right side view of an embodiment of the disclosure.

FIG. 4 is a perspective view of an embodiment of the disclosure showing a support member attached to a headrest.

FIG. 5 is a perspective in-use view of an embodiment of the disclosure showing a purse suspended from a support member.

FIG. 6 is an exploded view of an alternative embodiment of the disclosure.

FIG. 7 is a perspective in-use view of an alternative embodiment of the disclosure.

### (j) DETAILED DESCRIPTION OF THE INVENTION

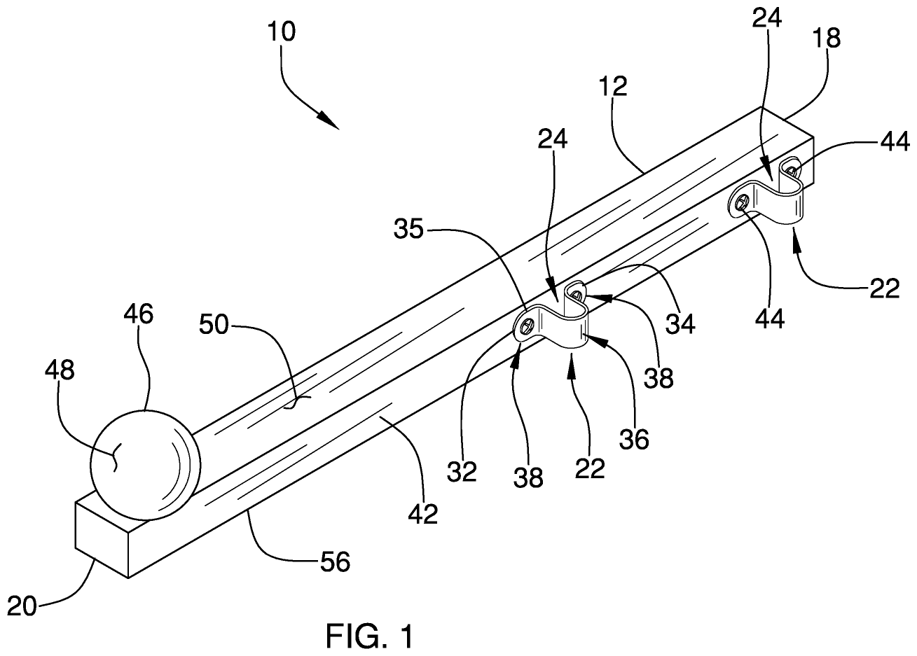

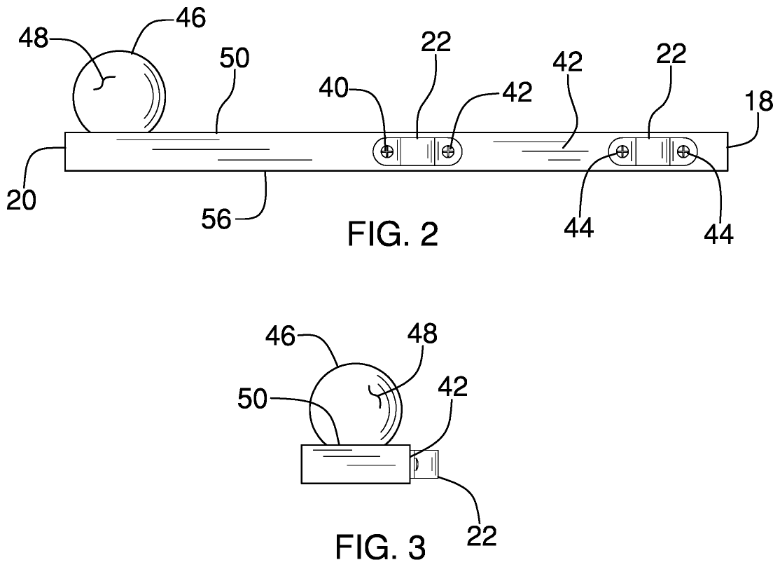

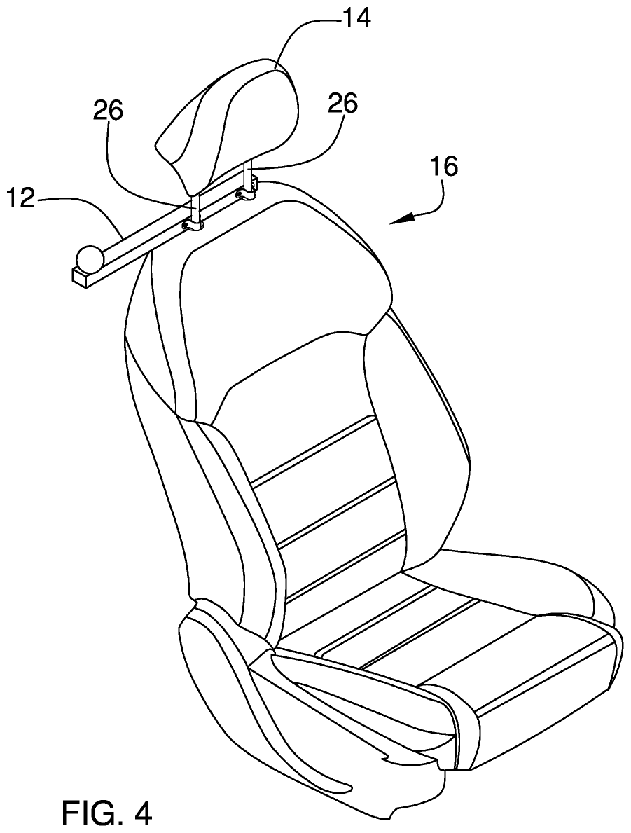

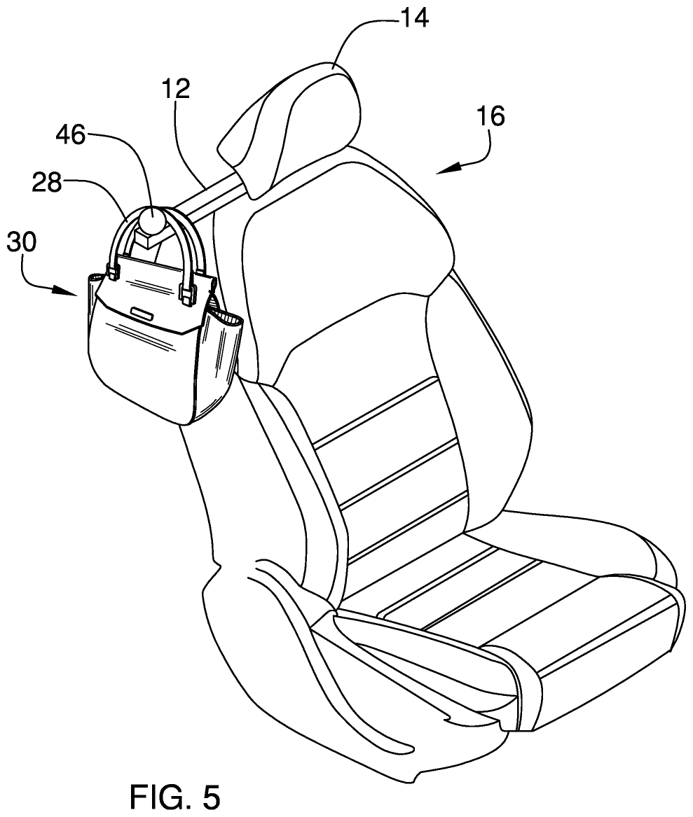

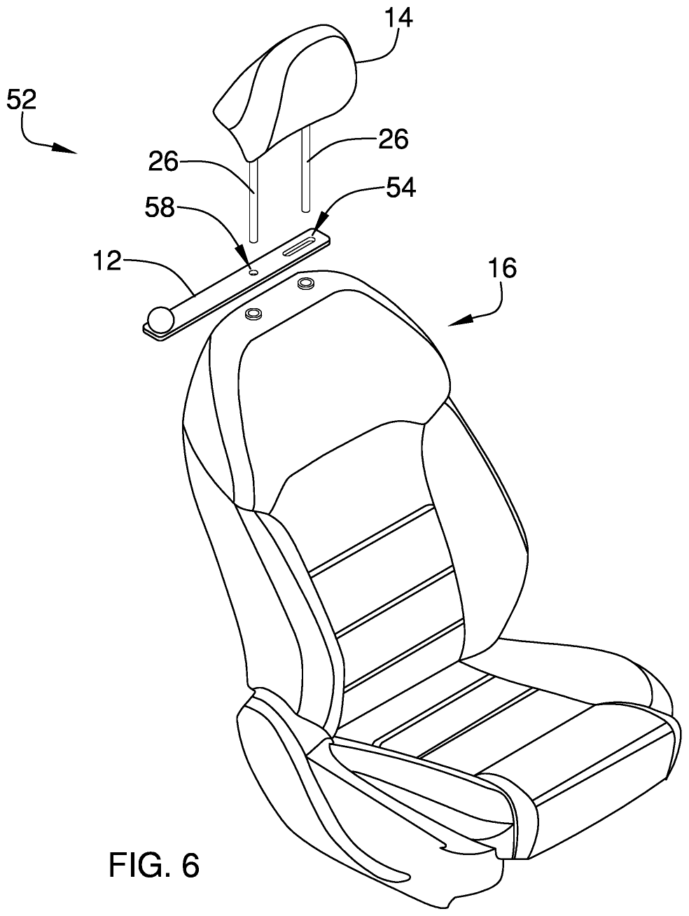

With reference now to the drawings, and in particular to FIGS. 1 through 7 thereof, a new holding device embodying the principles and concepts of an embodiment of the disclosure and generally designated by the reference numeral 10 will be described.

As best illustrated in FIGS. 1 through 7, the purse holding assembly 10 generally comprises a support member 12 that is engageable to a headrest 14 of a vehicle seat 16 such that the support member 12 is oriented to lie on a horizontal plane. The vehicle seat 16 is positioned in a vehicle which may comprise a passenger vehicle, a cargo vehicle or any other motorized vehicle that is commonly driven on public roadways. The support member 12 is elongated between a first end 18 and a second end 20 of the support member 12. The support member 12 may have a height and a depth being approximately equivalent such that the support member 12 has a cuboid shape.

A pair of engagements 22 is provided and each of the engagements 22 is attached to the support member 12. Each of the engagements 22 curves outwardly from the support member 12 to define a post opening 24 in each of the engagements 22. The post opening 24 in each of the engagements 22 insertably receives a respective one of a pair of posts 26 of the headrest 14 of the vehicle seat 16 for attaching the support member 12 to the pair of posts 26. In this way a strap 28 of a purse 30 can be extended over the support member 12 to suspend the purse 30 for storage.

Each of the engagements 22 has a primary end 32, a secondary end 34 and a rear surface 35 extending between the primary end 32 and the secondary end 34 and each of the engagements 22 is elongated between the primary end 32 and the secondary end 34. Each of the engagements 22 has a curved portion 36 that is positioned between a pair of end portions 38 and each of the end portions 38 is associated with a respective one of the primary end 32 and the secondary end 34. The curved portion 36 is concavely arcuate with respect to the rear surface 35 corresponding to each of the end portions 38 and each of the engagements 22 has a pair of fastener holes 40 each extending through a respective one of the end portions 38. The rear surface 35 corresponding to each of the end portions 38 is positioned against a front side 42 of the support member 12 such that the curved portion 36 of each of the engagements 22 curves away from the front side 42 thereby defining the post opening 24 in each of the engagements 22 between the curved portion 36 and the front side 42. A respective one of the engagements 22 is positioned adjacent to the first end 18 of the member and a respective one of the engagements 22 is spaced from the engagement 22 that is positioned adjacent to the first end 18.

A plurality of fasteners 44 is provided and each of the fasteners 44 extends through a respective one of the fasteners 44 holes in a respective one of the engagements 22. Each of the fasteners 44 engages the front side 42 of the support member 12 for attaching the engagements 22 to the support member 12. Additionally, each of the fasteners 44 may comprise a screw of other type of releasable fastener. A ball 46 is coupled to the support member 12 to inhibit the strap 28 of the purse 30 from sliding off of the support member 12. The ball 46 has an outer surface 48 that is bonded to a top surface 50 of the support member 12 and the ball 46 is positioned adjacent to the second end 20 of the support member 12.

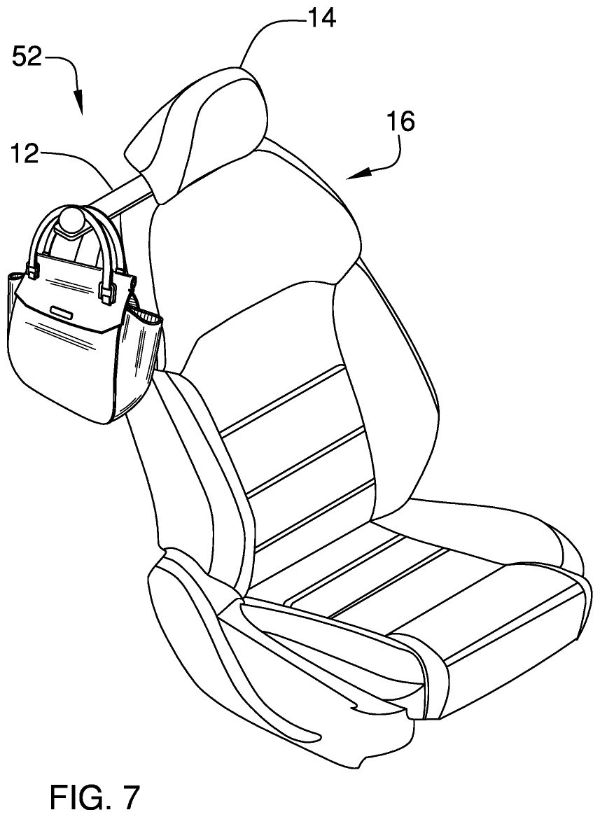

In an alternative embodiment 52 as is most clearly shown in FIG. 6, the support member 12 has a slot 54 extending through the top surface 50 and a bottom surface 56 of the support member 12 such that the slot 54 defines a respective one of the post openings 24 for insertably receiving a respective one of the posts 26 of the headrest 14. Additionally, the support member 12 may have a height being substantially less than a depth of the support member 12 such that the support member 12 has the shape of a panel. The slot 54 is positioned adjacent to the first end 18 of the support member 12 and the slot 54 is elongated to extend toward the second end 20 of the support member 12. In this way the slot 54 accommodates a variety of positions of the respective post 26 with respect to where the respective post 26 is positioned on the headrest 14. The support member 12 has an aperture 58 extending through the top surface 50 and the bottom surface 56 of the support member 12 such the aperture 58 defines a respective one of the post openings 24 for insertably receiving a respective one of the posts 26 of the headrest 14. Additionally, the aperture 58 is positioned between the slot 54 and the second end 20 of the support member 12.

In use, the headrest 14 is removed from the vehicle seat 16 and each of the posts 26 of the headrest 14 is extended through the post opening 24 in the respective engagement 22. Furthermore, the support member 12 is oriented such that the support member 12 is positioned behind the headrest 14 when the headrest 14 is re-attached to the vehicle seat 16. In this way the support member 12 extends laterally away from the vehicle seat 16 thereby facilitating the strap 28 of the purse 30 to be suspended on the support member 12. Thus, the purse 30 can be stored in the vehicle without being placed on the vehicle seat 16 or other location that would limit the occupancy of the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A purse holding assembly for suspending a purse from a headrest of a vehicle seat, said assembly comprising:
a support member being engageable to a headrest of a vehicle seat such that said support member is oriented to lie on a horizontal plane;
a pair of engagements, each of said engagements being attached to said support member, each of said engagements curving outwardly from said support member to define a post opening in each of said engagements, said post opening in each of said engagements insertably receiving a respective one of a pair of posts of the headrest of the vehicle seat for attaching said support member to the pair of posts wherein said support member is configured to have a strap of a purse extended over said support member to suspend the purse for storage; and
a ball being coupled to said support member wherein said ball is configured to inhibit the strap of the purse from sliding off of said support member.

2. The assembly according to claim 1, wherein:
each of said engagements has a primary end, a secondary end and a rear surface extending between said primary end and said secondary end, each of said engagements being elongated between said primary end and said secondary end, each of said engagements having a curved portion being positioned between a pair of end portions, each of said end portions being associated with a respective one of said primary end and said secondary end, said curved portion being concavely arcuate with respect to said rear surface corresponding to each of said end portions; and
each of said engagements has a pair of fastener holes each extending through a respective one of said end portions, said rear surface corresponding to each of said end portions being positioned against a front side of said support member such that said curved portion of each of said engagements curves away from said front side thereby defining said post opening in each of said engagements between said curved portion and said front side.

3. The assembly according to claim 2, further comprising a plurality of fasteners, each of said fasteners extending through a respective one of said fasteners holes in a respective one of said engagements and engaging said front side of said support member for attaching said engagements to said support member.

4. The assembly according to claim 1, wherein:
said support member is elongated between a first end and a second end of said support member; and
a respective one of said engagements is positioned adjacent to said first end of said member, a respective one of said engagements being spaced from said engagement that is positioned adjacent to said first end.

5. The assembly according to claim 4, further comprising said ball having an outer surface being bonded to a top surface of said support member, said ball being positioned adjacent to said second end of said support member.

6. A purse holding assembly for suspending a purse from a headrest of a vehicle seat, said assembly comprising:
a support member being engageable to a headrest of a vehicle seat such that said support member is oriented to lie on a horizontal plane, said support member being elongated between a first end and a second end of said support member;
a pair of engagements, each of said engagements being attached to said support member, each of said engagements curving outwardly from said support member to define a post opening in each of said engagements, said post opening in each of said engagements insertably receiving a respective one of a pair of posts of the headrest of the vehicle seat for attaching said support member to the pair of posts wherein said support member is configured to have a strap of a purse extended over said support member to suspend the purse for storage, each of said engagements having a primary end, a secondary end and a rear surface extending between said primary end and said secondary end, each of said engagements being elongated between said primary end and said secondary end, each of said engagements having a curved portion being positioned between a pair of end portions, each of said end portions being associated with a respective one of said primary end and said secondary end, said curved portion being concavely arcuate with respect to said rear surface corresponding to each of said end portions, each of said engagements having a pair of fastener holes each extending through a respective one of said end portions, said rear surface corresponding to each of said end portions being positioned against a front side of said support member such that said curved portion of each of said engagements curves away from said front side thereby defining said post opening in each of said engagements between said curved portion and said front side, a respective one of said engagements being positioned adjacent to said first end of said member, a respective one of said engagements being spaced from said engagement that is positioned adjacent to said first end;
a plurality of fasteners, each of said fasteners extending through a respective one of said fasteners holes in a respective one of said engagements and engaging said front side of said support member for attaching said engagements to said support member; and
a ball being coupled to said support member wherein said ball is configured to inhibit the strap of the purse from sliding off of said support member, said ball having an outer surface being bonded to a top surface of said support member, said ball being positioned adjacent to said second end of said support member.

7. The assembly according to claim 6, wherein said support member has a slot extending through said top surface and a bottom surface of said support member such that said slot defines a respective one of said post openings for insertably receiving a respective one of the posts of the headrest, said slot being positioned adjacent to said first end of said support member, said slot being elongated to extend toward said second end of said support member.

8. The assembly according to claim 7, wherein said support member has an aperture extending through said top surface and a bottom surface of said support member such said aperture defines a respective one of said post openings for insertably receiving a respective one of the posts of the headrest, said aperture being positioned between said slot and said second end of said support member.

9. A purse holding system for suspending a purse from a headrest of a vehicle seat, said system comprising:
a vehicle seat having a headrest, said headrest having a pair of posts each slidably engaging a top of said vehicle seat;
a support member being engageable to said headrest of said vehicle seat such that said support member is oriented to lie on a horizontal plane, said support member being elongated between a first end and a second end of said support member;
a pair of engagements, each of said engagements being attached to said support member, each of said engagements curving outwardly from said support member to define a post opening in each of said engagements, said post opening in each of said engagements insertably receiving a respective one of a pair of said posts of said headrest of said vehicle seat for attaching said support member to said pair of posts wherein said support member is configured to have a strap of a purse extended over said support member to suspend the purse for storage, each of said engagements having a primary end, a secondary end and a rear surface extending between said primary end and said secondary end, each of said engagements being elongated between said primary end and said secondary end, each of said engagements having a curved portion being positioned between a pair of end portions, each of said end portions being associated with a respective one of said primary end and said secondary end, said curved portion being concavely arcuate with respect to said rear surface corresponding to each of said end portions, each of said engagements having a pair of fastener holes each extending through a respective one of said end portions, said rear surface corresponding to each of said end portions being positioned against a front side of said support member such that said curved portion of each of said engagements curves away from said front side thereby defining said post opening in each of said engagements between said curved portion and said front side, a respective one of said engagements being positioned adjacent to said first end of said member, a respective one of said engagements being positioned spaced from said engagement that is positioned adjacent to said first end;
a plurality of fasteners, each of said fasteners extending through a respective one of said fasteners holes in a respective one of said engagements and engaging said front side of said support member for attaching said engagements to said support member; and
a ball being coupled to said support member wherein said ball is configured to inhibit the strap of the purse from sliding off of said support member, said ball having an outer surface being bonded to a top surface of said support member, said ball being positioned adjacent to said second end of said support member.
